(19) United States
(12) Patent Application Publication
(10) Pub. No.: US 2007/0208132 A1
(43) Pub. Date: Sep. 6, 2007

(54) Crosslinkable Silicone Compositions

(75) Inventors: Gilbert Geisberger, Altoetting (DE); Hans Lautenschlager, Haiming (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/677,635

(22) Filed: Feb. 22, 2007

(30) Foreign Application Priority Data
Mar. 2, 2006 (DE) 10 2006 009 745.9

(51) Int. Cl. C08L 83/04; B32B 27/00

(52) U.S. Cl. 524/588; 524/861

(57) ABSTRACT

The invention relates to crosslinkable compositions (V) containing
(A) linear organopolysiloxanes (A) having alkenyl groups,
(B) linear organopolysiloxanes (B) which have diorganosilyloxy units and Si—H groups and are obtainable by a cohydrolysis process in which diorganodichlorosilanes and monochlorosilanes and optionally dichlorosilanes, at least the monochlorosilanes or dichlorosilanes containing Si—H groups, are hydrolyzed with water, and
(C) catalysts (C) promoting the addition of Si—H groups at an aliphatic carbon-carbon double bond.

### BACKGROUND OF THE INVENTION

1. Field of the Invention

The invention relates to crosslinkable compositions (V) containing linear organopolysiloxanes (A) having alkenyl groups, linear organopolysiloxanes (B) having diorganosilyloxy units and Si—H groups, obtainable by a cohydrolysis process, and catalysts (C) which promote the addition of Si—H groups at an aliphatic carbon-carbon double bond.

2. Background Art

A trend in the label-producing industry is the use of rapidly crosslinking silicone release coating systems. In addition to polymer type, temperature, catalyst type and catalyst concentration, the crosslinking agent is of decisive importance for the rate of the hydrosilylation reaction. Usually organohydrogenpolysiloxanes, for example as described in U.S. Pat. No. 4,347,346 A, are used in such release coating systems.

The preparation of the organohydrogenpolysiloxanes is effected in general via an acid-catalyzed equilibration. Typical processes are described in EP 797612 A, while EP 851000 A describes branched organohydrogenpolysiloxanes as a constituent of crosslinking system, the preparation of which are also effected by acid-catalyzed equilibration.

WO 03/029375 discloses the use of mixtures of partially branched organohydrogenpolysiloxanes as crosslinking agents in silicone release coating materials. The preparation of these organohydrogenpolysiloxanes is effected by reaction of cyclic organohydrogenpolysiloxanes with trimethylsilyl-endcapped polydimethylsiloxane and an acid catalyst.

EP 896041 A discloses increasing the release force in silicone release coating systems by incorporating partly incompatible organohydrogenpolysiloxanes. The preparation of these organohydrogenpolysiloxanes is effected by reaction of phenyl-functional polydimethylsiloxanes with trimethylsilyl-endcapped organohydrogenpolysiloxanes in the presence of an acid catalyst. The organohydrogenpolysiloxanes thus obtained may be adversely affected in their reaction rate in hydrosilylation reactions by insufficient equilibration or by residues of the acidic catalyst used.

The importance of contamination by the catalyst with respect to the hydrosilylation rate has already been recognized in the preparation of alkenyl-functional polysiloxanes. In WO 2005/005544, paper coating materials which are prepared employing a phosphazene base catalyst are described. As a result of employing this catalyst, process-related impurities can be reduced to such an extent that the paper coating composition based thereon can be cured using very small amounts, 2-40 ppm by weight, of platinum

### SUMMARY OF THE INVENTION

It has now been surprisingly discovered that addition-crosslinkable coating systems employing alkenyl-functional organopolysiloxanes can be cured more effectively if Si—H-functional organopolysiloxane crosslinkers prepared by cohydrolysis are employed instead of otherwise similar crosslinkers prepared by other methods such as equilibration.

### DETAILED DESCRIPTION OF THE PREFERRED EMBODIMENT(S)

The invention relates to crosslinkable compositions (V) containing
(A) alkenyl group-containing organopolysiloxanes (A) of the general formula 1

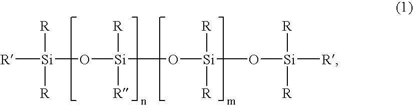

in which
R is a monovalent, SiC-bonded, optionally substituted C₁₋₁₈ hydrocarbon radical free of aliphatic carbon-carbon double bonds,
R″ is a monovalent, SiC-bonded, optionally substituted C₁₋₁₈ hydrocarbon radical containing at least one aliphatic carbon-carbon double bond,
R′ is a radical R or R″,
m is an integer from 40 to 1000,
n is an integer from 0 to 10 and
m+n is an integer from 40 to 1000,
(B) linear organopolysiloxanes (B) which contain diorganosilyloxy units and Si—H groups, and are obtainable by a cohydrolysis process in which diorganodichlorosilanes and monochlorosilanes and optionally dichlorosilanes, at least the monochlorosilanes or dichlorosilanes containing Si—H groups, are hydrolyzed with water, and
(C) catalysts (C) which promote the addition of Si—H groups at an aliphatic carbon-carbon double bond.

The crosslinkable compositions (V) show a substantial increase in reactivity compared with those crosslinkable compositions which use organohydrogenpolysiloxanes (B) prepared by equilibration. The crosslinkable compositions (V) therefore have higher curing rates than crosslinkable compositions whose organohydrogenpolysiloxanes were prepared by equilibration or polymerization. In particular, the compositions (V) show a high crosslinking rate at low curing temperature.

It was found that organohydrogenpolysiloxanes which were prepared by equilibration or polymerization contain impurities which reduce reactivity in crosslinkable compositions. Organohydrogenpolysiloxanes (B) prepared by cohydrolysis have no impurities which inhibit crosslinking.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl and phenanthryl radicals; alkaryl radicals such as the o-, m- and p-tolyl radicals, xylyl radicals and ethylphenyl radicals; and aralkyl radicals such as the benzyl radical and the α- and the β-phenylethyl radicals. Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals such as the o-, m- and p-chlorophenyl radicals. The radical R is preferably a monovalent alkyl radical having 1 to 6 carbon atoms, the methyl radical being particularly preferred.

Examples of radicals R″ are radicals having a terminal aliphatic carbon-carbon double bond, preferably having 2 to 10 carbon atoms, such as the vinyl, 5-hexenyl, cyclohexenyl, 1 propenyl, allyl, 3-butenyl and 4-pentenyl radicals.

In the formula (A), m preferably has a value of from 50 to 200, more preferably from 100 to 160, and n preferably has a value of from 1 to 6, in particular from 2 to 5.

The organopolysiloxanes (A) preferably have an average viscosity of from 100 to 10,000 mPa·s at 25° C., preferably from 200 to 1000 mPa·s at 25° C., and are prepared by customary processes, for example by hydrolysis of allylmethyldichlorosilane and subsequent equilibration of the resulting hydrolysis product with cyclic polydimethylsiloxane and a vinyl-terminated dimethylsiloxane using a suitable catalyst.

Preferably, the linear organopolysiloxanes (B) bearing diorganosilyloxy units and Si—H groups are prepared in a process in which in a first step, diorganodichlorosilanes, monochlorosilanes, and optionally dichlorosilanes, at least the monochlorosilanes or dichlorosilanes containing Si—H groups, are reacted with not more than 0.5 mol of water per mole of hydrolyzable chlorine to give a partial hydrolysis product (T) and gaseous hydrogen chloride, and in a second step, the partial hydrolysis product (T) is treated with water with formation of hydrochloric acid in order to remove the SiCl groups still present, a hydrolysis product (H) containing the organopolysiloxanes (B) being obtained. The hydrolyzable chlorine is present in the form of SiCl groups. In the first step, preferably at least 0.3 mol of water is used per mole of hydrolyzable chlorine.

The linear organopolysiloxanes (B) bearing diorganosilyloxy units and Si—H groups preferably have the general formula

R³₃SiO(SiR³₂O)ₓ(SiR¹₂O)_{y}SiR³₃ (2)

in which
R³ is hydrogen or a C₁₋₁₈ hydrocarbon radical optionally substituted by halogen or cyano radicals,
R¹ is a C₁₋₁₈ hydrocarbon radical optionally substituted by halogen or cyano radicals,
x is an integer from 0 to 1000 and
y is an integer from 1 to 1000,
with the proviso that at least one radical R³ is hydrogen.

The diorganodichlorosilanes used in the first step preferably have the general formula

R¹₂SiCl₂ (3)

in which R¹ is defined above, the monochlorosilanes preferably have the formula

R³₃SiCl (4)

and the dichlorosilanes used in the first step preferably have the general formula

R³₂SiCl₂ (5)

in which R³ is as defined above. Examples of the hydrocarbon radicals R³ and R¹ are, for example the radicals enumerated for R. The radicals R³ and R¹ are preferably phenyl radicals or linear alkyl radicals, in particular alkyl radicals having 1 to 10, especially 1 to 6 carbon atoms. Particularly preferred hydrocarbon radicals R³ and R¹ are the n-propyl, ethyl, and methyl radicals, in particular the methyl radical.

In the formula (B), x preferably has a value of not more than 200, in particular not more than 50, and y preferably has a value of not more than 500, in particular not more than 250.

Preferred mixtures used in the first step are (methyl=Me):
Me₃SiCl/Me₂SiCl₂/MeSiHCl₂,
Me₃SiCl/PropylMeSiCl₂/MeSiHCl₂,
Me₂SiCl/Me₂SiCl₂/PhenylMeSiCl₂/MeSiHCl₂,
Me₂SiHCl/Me₂SiCl₂, and
Me₂SiHCl/Me₂SiCl₂/MeSiHCl₂,

The organopolysiloxanes (B) preferably have a viscosity of from 1 to 1200 mPa·s, in particular from 5 to 150 mPa·s, at 25° C.

The first step of the process for the preparation of organopolysiloxanes (B) is preferably carried out in the presence of a water-insoluble organic solvent having a density of not more than 0.9 kg/l (L). In the context of this invention, a water-insoluble organic solvent (L) is to be understood as meaning a solvent in which the solubility at 25° C. is less than 1 g of solvent/100 g of water, for example, toluene, xylene, carbon tetrachloride or n-octane. Toluene is preferred.

The partial hydrolysis product (T) formed in the first step partly comprises Cl-terminated and optionally OH-terminated organopolysiloxanes and cyclic siloxanes. The content of SiCl groups still present in the partial hydrolysis product (T) is preferably from 0.5 to 5% by weight, in particular from 1.0 to 2% by weight. The first step of the process is preferably carried out at a temperature of from 0 to 80° C., in particular from 10 to 30° C., and at a pressure of from 900 to 1600 hPa. The hydrogen chloride gas obtained in the first step can be used directly in other processes, for example with methanol for the preparation of chloromethane, which in turn is used in the methylchlorosilane synthesis. Thus, the chlorine can be circulated without being released to the environment.

In the second step, the remaining chlorine content of the partial hydrolysis product (T) is completely reacted with water. The hydrochloric acid formed thereby preferably has an HCl content of from 3 to 20% by weight, in particular from 5 to 10% by weight. In a particularly desirable embodiment of the process, hydrochloric acid formed in the second step is used as a water donor in the first step. Preferably, at least 90%, and in particular at least 95% of the hydrochloric acid formed in the second step are used in the first step, and in a particularly preferred embodiment of the process, water is used in the second step at most in an amount such that the water of the hydrochloric acid formed is completely reacted in the first step.

The chain lengths and viscosities of the organopolysiloxanes (B) prepared are controlled via the weight ratio of the chlorosilane mixtures used. The second step of the process is preferably carried out at a temperature of from 0 to 100° C., in particular from 10 to 60° C., and at the pressure of the surrounding atmosphere, i.e. at from 900 to 1100 hPa.

In a preferred embodiment, a rearrangement catalyst is added to the hydrolysis product (H) obtained after the second step, in order to increase the proportion of poorly volatile, substantially linear organopolysiloxanes. These catalysts are preferably strongly acidic ion exchangers, most preferably based on polystyrene and functionalized with sulfo groups. Preferably, the catalyst is introduced into a tubular reactor, in particular as a loose bed, but it can also be present as a packed filling.

In a further preferred embodiment, the hydrolysis product (H) obtained after the second step is separated into organopolysiloxanes (B) and a readily volatile mixture (G) containing organopolysiloxanes. The mixture (G) is preferably recycled to the first and/or second step or completely or partly subjected to a rearrangement reaction to give sparingly volatile, substantially linear organopolysiloxanes.

The mixture (G) is preferably separated off by distillation, this most preferably being carried out in two stages into mixtures (G1) and (G2). The mixtures (G), (G1), (G2) are predominantly short-chain linear and cyclic organohydrogensiloxanes optionally containing solvent (L). In a first distillation stage, primarily the optionally used solvent (L) is separated, and can be recycled to the first or second step of the process. The second distillation stage serves primarily to separate an organohydrogensiloxane mixture which is preferably recycled to the distillation. Separating off the distillates can serve for obtaining cyclic organohydrogenpolysiloxanes.

The first distillation stage is preferably carried out at a temperature of from 50 to 150° C., in particular from 60 to 120° C., and an absolute pressure of from 50 to 1100 hPa, while the second distillation stage is preferably carried out at a temperature of from 80 to 200° C., in particular from 120 to 160° C., and an absolute pressure of from 1 to 30 hPa.

Preferably, the mixtures (G), (G1), (G2) are recycled to the first step. Most preferably, optionally after removal of the solvent (L), a rearrangement reaction in the presence of a rearrangement catalyst is carried out with the mixtures (G), (G1), (G2). The catalysts are preferably the catalysts which are described above and can be used in the case of the hydrolysis product (H).

During the contact time with the catalyst, the predominant part, preferably from 80 to 95% by weight, of the volatile organohydrogenpolysiloxane undergo rearrangement to sparingly volatile, substantially linear organohydrogenpolysiloxanes. The mixtures (G), (G1), (G2) preferably contain up to 60% by weight of solvent (L), in particular as a mixture of the mixtures (G1) and (G2), and particularly with from 15 to 25% of solvent (L).

The mixtures (G), (G1), (G2) can be brought into contact with a catalyst in a reaction vessel. Any desired reaction vessels, such as stirred tank and in particular tubular reactors, can be used as the reaction vessel. The mixtures (G), (G1), (G2) can be added from above to flow over the catalyst bed or they may flow by pumping from below upward through the catalyst column. Flow from below by means of a pump is preferred.

The amount of catalyst, the residence time, and the temperature determine the degree of rearrangement. Contact times of from one minute to one hundred and twenty minutes are preferred, and contact times from two to thirty minutes are particularly preferred. The rearrangement is preferably carried out at temperatures of from −30° C. to +200° C., more preferably from 0 to 30° C., and preferably at the pressure of the surrounding atmosphere, i.e. about 900 to 1100 hPa.

The process can be carried out batchwise, semicontinuously or completely continuously, a completely continuous procedure of two steps, wherein optionally the isolation, processing and feeding of the mixtures (G), (G1), (G2) are preferably carried out in an integrated plant.

The organopolysiloxanes (B) preferably have a content of Si-bonded hydrogen atoms of from 0.1 to 5% by weight, in particular from 0.6 to 1.6% by weight, and have an average viscosity of from 10 to 1000 mPa·s, in particular from 50 to 200 mPa·s, at 25° C.

Organosilicon compound (B) is preferably used in amounts of from 0.5 to 3.5, preferably from 1.0 to 3.0 gram atoms of Si-bonded hydrogen per mole of hydrocarbon radical having a terminal aliphatic carbon-carbon double bonds in the organopolysiloxane (A). The proportion of organopolysiloxane (B) in the crosslinkable compositions (V) is preferably not more than 15%.

In the case of the crosslinkable compositions (V), any catalysts(C) which promotes the addition of Si-bonded hydrogen at aliphatic double bonds may be used for promoting the crosslinking reaction. Metals from the group of the platinum metals or compounds or complexes thereof are preferably used as catalysts (C). Examples of such catalysts are metallic and finely divided platinum which may be optionally present on supports such as silica, alumina or active carbon, compounds or complexes of platinum, such as platinum halides, e.g. PtCl₄, H₂PtCl₆.6H₂O, Na₂PtCl₄.4H₂O, platinum-olefin complexes, platinum-alcohol complexes, platinum-alcoholate complexes, platinum-ether complexes, platinum-aldehyde complexes, platinum-ketone complexes, including reaction products of H₂PtCl₆.6H₂O and cyclohexanone, platinum-vinylsiloxane complexes such as platinum-1,3-divinyl-1,1,3,3-tetramethyldisiloxane complexes with or without a content of detectable inorganically bonded halogen, bis(gamma-picoline)platinum dichloride, trimethylenedipyridineplatinum dichloride, dicyclopentadieneplatinum dichloride, dimethylsulfoxyethyleneplatinum(II) dichloride, cyclooctadieneplatinum dichloride, norbornadieneplatinum dichloride, gamma-picolineplatinum dichloride, cyclopentadieneplatinum dichloride, and reaction products of platinum tetrachloride with olefin and primary amine or secondary amine or primary and secondary amine, for example the reaction product of platinum tetrachloride dissolved in 1-octene with sec-butylamine or ammonium-platinum complexes.

The catalysts (C) are preferably used in amounts of from 10 to 1000 ppm by weight (parts by weight per million parts by weight), preferably from 20 to 200 ppm by weight, and in particular from 50 to 100 ppm by weight, calculated in each case as elemental platinum metal and based on the total weight of the organosilicon compounds (A) and (B).

The crosslinkable compositions may contain compositions which retard the addition of Si-bonded hydrogen at an aliphatic multiple bond at room temperature, so-called inhibitors (D). Any inhibitor which performs this function may be used, and many such inhibitors are known to those skilled in the art.

Examples of inhibitors (D) are 1,3-divinyl-1,1,3,3-tetramethyl-disiloxane, benzotriazole, dialkylformamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyne-2,5-diol and 3,5-dimethyl-1-hexyn-3-ol, 3,7-dimethyloct-1-yn-6-en-3-ol, a mixture of diallyl maleate and vinyl acetate, maleic monoesters, and inhibitors such as the compound of the formula HC═C—C(CH₃)(OH)—CH₂—CH₂—CH═C(CH₃)₂, commercially available as Dehydrolinalool® from BASF.

If inhibitor (D) is concomitantly used, it preferably is used in amounts of from 0.01 to 10% by weight, more preferably from 0.01 to 3% by weight, based on the total weight of the organosilicon compounds (A) and (B).

Examples of further constituents which may be concomitantly used in the crosslinkable compositions (V) are agents for adjusting the release force, antimisting additives, organic solvents, adhesion promoters, and pigments.

Examples of agents for adjusting the release force in the compositions (V) are silicone resins, composed of units of the general formula 6

R⁵R⁴₂SiO_{1/2} (6)

and SiO₂, so-called MQ resins, in which
R⁵ is a hydrogen atom or a monovalent SiC-bonded, optionally substituted C₁₋₁₈ hydrocarbon radical,
R⁴ is a monovalent, SiC-bonded, optionally substituted C₁₋₁₈ hydrocarbon radical free of aliphatic carbon-carbon double bonds and having 1 to 18 carbon atoms,
wherein the units of the general formula (6) may be identical or different.

The ratio of units of the general formula (6) to SiO₂ units is preferably from 0.6 to 2. The silicone resins are preferably used in amounts of from 5 to 80% by weight, based on the total weight of the organosilicon compounds (A) and (B).

Examples and preferred examples of R⁵ are hydrocarbon radicals listed for R¹. Examples and preferred examples for R⁴ are the hydrocarbon radicals listed for R.

Examples of suitable organic solvents are benzines, e.g. alkane mixtures having a boiling range from 70° C. to 180° C., n-heptane, benzene, toluene and xylenes, halogenated alkanes having 1 to 6 carbon atom(s) such as methylene chloride, trichloroethylene and perchloroethylene, ethers such as di-n-butyl ether, esters such as ethyl acetate, and ketones such as methyl ethyl ketone, methyl isobutyl ketone (MIBK) and cyclohexanone.

If organic solvents are concomitantly used, they are preferably used in amounts of from 10 to 90% by weight, more preferably from 10 to 70% by weight, based on the total weight of the organosilicon compounds (A) and (B).

The sequence in which the constituents (A), (B), (C) and (optionally) (D) are mixed is not critical, but it has proven useful in practice to add the catalyst (C) last to the mixture of the other constituents.

The crosslinking of the compositions (V) is preferably effected at from 70° C. to 180° C. Ovens, e.g. forced-circulation drying ovens, heating tunnels, heated rolls, heated plates or heat radiation in the infrared range are preferably used as energy sources for crosslinking by heating.

Apart from thermal cure, the compositions (V) can also be crosslinked by irradiation with ultraviolet light or by irradiation with UV and IR light. Ultraviolet light used is usually that having a wavelength of 253.7 nm. A multiplicity of lamps which emit ultraviolet light having a wavelength of from 200 to 400 nm, and which preferably emit ultraviolet light having a wavelength of 253.7 nm, are commercially available.

The invention furthermore relates to moldings which can be produced by crosslinking the compositions (V). The moldings are preferably coatings, more preferably coverings repelling tacky substances, i.e. “abhesives.”

The invention furthermore relates to a process for the production of coatings by application of compositions (V) to surfaces to be coated and subsequently crosslinking the compositions (V).

The compositions (V) are preferably used for the production of coverings repelling tacky substances, for example for the production of release papers. Coverings repelling tacky substances are produced by application of compositions (V) to the surfaces to be made repellent and crosslinking the compositions (V). Application of the compositions (V) to the surfaces to be coated, can be effected in any desired manner suitable for the production of coatings from liquid substances, for example by immersion, brushing, pouring, spraying, roll-coating, printing, e.g. by means of an offset gravure coating apparatus, knife or doctorblade coating or by means of an airbrush. The layer thickness is preferably from 0.3 to 6 μm, more preferably from 0.5 to 2.0 μm.

The surfaces which can be treated may be surfaces of any desired substances solid at room temperature and 1012 mbar (abs.). Examples of such surfaces are those of paper, wood, cork and plastic films, e.g. polyethylene films, polyester films and polypropylene films, woven and unwoven cloth of natural or synthetic fibers, ceramic articles, glass, including glass fibers, metals, paper coated with polyethylene, and boards, including those of asbestos. Paper may be of low-quality paper types, such as absorptive papers, including raw craft paper, i.e. craft paper not pretreated with chemicals and/or polymeric natural substances, having a weight of from 60 to 150 g/m², unsized papers, papers having high freeness, wood-containing papers, papers which have not been supercalendered or calendered, papers which are smooth on one side owing to the use of a Yankee dryer during their production without further complicated measures and are therefore referred to as “machine-glazed papers”, uncoated papers or papers produced from paper wastes, i.e. so-called waste papers. However, the papers to be treated may, of course, also be high-quality paper types, such as low-absorption papers, sized papers, papers having low freeness, wood-free papers, calendered or supercalendered papers, glassing papers, parchmentized papers or precoated papers. Boards, too, may be of high or low quality.

The compositions (V) are suitable, for example, for the production of release, liner and abhesive papers, including abhesive papers which are used in the production of cast films, decorative films, or foams, including polyurethane foams. The compositions are furthermore suitable for the production of release, liner and abhesive boards, films and cloths, for the treatment of the backs of self-adhesive tapes or self-adhesive films or the printed sides of self-adhesive labels. The compositions (V) are also suitable for the treatment of packaging material such as those of paper, cardboard boxes, metal foils and drums, e.g. board, plastic, wood or iron, which are intended for the storage and/or transport of tacky goods, such as adhesives, tacky foods, e.g. cakes, honey, candy, or meat; bitumen, asphalt, greased materials and raw rubber. A further example of the use of the compositions (V) is the treatment of substrates for the transfer of pressure-sensitive adhesive layers in the so-called “transfer process”.

The compositions (V) are suitable for the production of the self-adhesive materials bonded to the release paper, both by the off-line process and by the in-line process. In the off-line process, the composition (V) is applied to the paper and crosslinked, after which, in a subsequent stage, usually after rolling of the release paper onto a roller and after storage of the roll, an adhesive film which is present, for example, on a label face paper is applied to the coated paper and the composite is then pressed together. In the in-line process, the composition (V) is applied to the paper and crosslinked, the silicone covering is coated with the adhesive, the label face paper is then applied to the adhesive and the composite is finally pressed together. In the off-line process, the winding speed depends on the time which is required for making the silicone covering nontacky. In the in-line process, the process speed depends on the time which is required for making the silicone covering migration-free.

All above symbols of the above formulae have their meanings in each case independently of one another.

In the following use examples, all data for parts and percentages are based on weight. The examples were carried out at a pressure of the surrounding atmosphere, i.e. at about 1012 mbar, and at room temperature, i.e. at about 21° C. The viscosities were measured at 25° C.

### EXAMPLES

### EXAMPLES ACCORDING TO THE INVENTION

Organohydrogenpolysiloxane V1 is prepared analogously to the process described in EP 1589056 A, Example 1.

### COMPARATIVE EXAMPLES NOT ACCORDING TO THE INVENTION

Organohydrogenpolysiloxane V2 is prepared by equilibration of trimethyl-terminated and trimethylsilyl-terminated polydimethyldisiloxane under acidic catalysis conditions with phosphonitrilic chloride by the process described in EP 797612 B1, Example 6.

The crosslinking agents V1 and V2 each have a viscosity of 30 mPa·s and a hydrogen content of 1.15% and correspond to the average formula Me₃Si(SiHMe)₁₀(SiMe₂)₃₀SiMe₃. They differ in their mode of preparation, which is responsible for the differences between them.

A comparison of the applications of the paper coating systems is effected in a standard formulation comprising 100 parts by weight of DEHESIVE® 920, a divinyl-endcapped polydimethylsiloxane available from Wacker Chemie AG, Munich, having a viscosity of 500 mpa.s with a content of
0.25% by weight of ethynylhexanol as an inhibitor
2.9 parts by weight of crosslinking agent V
1.0 or 0.7 part by weight of the Pt catalyst Wacker® OL having a Pt content of 10,000 ppm.

The crosslinking agents V are added to the standard formulation. These mixtures are used for paper coating.

The substrate used is paper from Ahlstrom with the name Glassine® Larice Tipo 325, 62 g/m². The coating is effected on a pilot coating unit from Dixon with a 5-roll application unit at various application speeds. The application roller is operated at 95% of the paper speed. The coating is cured at 160° C. in a drying oven having a length of 3 m.

The percentage of extractable silicone fractions as a function of the residence time serves as a measure of the crosslinking rate. The influence of the crosslinking agents on the curing of the coating system is determined immediately by means of a migration test and smear test and in parallel by means of extraction of uncrosslinked fractions in MIBK. The influence of the crosslinking agents on the adhesion of the coating system to the substrate is determined by means of the rub-off test.

The test methods are described in the brochure DEHESIVE® Testmethoden [DEHESIVE® Test Methods], 2001 Edition, from Wacker Chemie AG.

The results are summarized in the table. It can be seen that lower extract values are obtained with crosslinking agent V1 compared with crosslinking agent V2 with identical formulation and curing conditions. Extract values serve as a measure of the degree of crosslinking of the system. Thus, the lower extract values with V1 indicate the higher reaction rate compared with V2.

| | | | | | | | Si | Si |
|---|---|---|---|---|---|---|---|---|
| | PPM | Machine speed | Residence | | Smear | | Application | extract |
| Formulation | Pt | (m/min) | time(s) | Migration | Test | Rub-off | (g/m²) | (%) |
| 100 parts of DEHESIVE ® 920 | 100 | 45 | 4 | 1 | 1 | 1 | 1.70 | 3.2 |
| 2.9 parts of crosslinking agent | | 60 | 3 | 1 | 1 | 1 | 1.66 | 3.2 |
| V1 | | 90 | 2 | 1 | 1 | 1 | 1.55 | 3.3 |
| 1.0 part of catalyst | | 120 | 1.5 | 1 | 1 | 1 | 1.49 | 3.6 |
| 100 parts of DEHESIVE ® 920 | 70 | 45 | 4 | 1 | 1 | 1 | 1.70 | 3.3 |
| 2.9 parts of crosslinking agent | | 60 | 3 | 1 | 1 | 1 | 1.52 | 3.7 |
| V1 | | 90 | 2 | 1 | 1 | 1 | 1.58 | 3.8 |
| 0.7 part of catalyst | | 120 | 1.5 | 1 | 1 | 1 | 1.48 | 4.5 |
| 100 parts of DEHESIVE ® 920 | 100 | 45 | 4 | 1 | 1 | 1 | 1.68 | 3.3 |
| 2.9 parts of crosslinking agent | | 60 | 3 | 1 | 1 | 1 | 1.51 | 3.5 |
| V2* | | 90 | 2 | 1 | 1 | 1 | 1.42 | 3.6 |
| 1.0 part of catalyst | | 120 | 1.5 | 1 | 2 | 1 | 1.34 | 4.0 |
| 100 parts of DEHESIVE ® 920 | 70 | 45 | 4 | 1 | 1 | 1 | 1.68 | 3.6 |
| 2.9 parts of crosslinking agent | | 60 | 3 | 1 | 1 | 1 | 1.57 | 3.6 |
| V2* | | 90 | 2 | 1 | 2 | 1 | 1.4 | 4.4 |
| 0.7 part of catalyst | | 120 | 1.5 | 1 | 2 | 1 | 1.41 | 5.3 |

*not according to the invention

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A crosslinkable composition (V) containing
(a) at least one alkenyl group-containing organopolysiloxane (A) of the formula 1 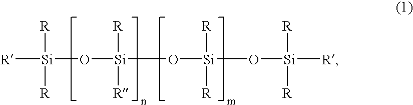
in which
R is a monovalent, SiC-bonded, optionally substituted C₁₋₁₈ hydrocarbon radical free of aliphatic carbon-carbon double bonds,
R″ is a monovalent, SiC-bonded, optionally substituted C₁₋₁₈ hydrocarbon radical containing at least one aliphatic carbon-carbon double bond,
R′ is a radical R or R″,
m is an integer from 40 to 1000,
n is an integer from 0 to 10 and
m+n has a value from 40 to 1000,
(b) linear organopolysiloxanes (B) comprising both diorganosilyloxy units and Si—H groups and obtained by cohydrolysis with water of diorganodichlorosilanes, monochlorosilanes, and optionally dichlorosilanes, at least one of the monochlorosilanes or dichlorosilanes containing Si—H groups, and
(c) at least one catalyst (C) which promotes the addition of Si—H groups at an aliphatic carbon-carbon double bond.

2. The crosslinkable composition of claim 1, wherein the linear organopolysiloxanes (B) have the formula 2
R³₃SiO(SiR³₂O)ₓ(SiR¹₂O)_{y}SiR³₃ (2)
wherein
R³ is hydrogen or a C₁₋₁₈ hydrocarbon radical optionally substituted by halogen or cyano radicals,
R′ is a C₁₋₁₈ hydrocarbon radical optionally substituted by halogen or cyano radicals,
x is an integer from 0 to 1000 and
y is an integer from 1 to 1000,
with the proviso that at least one radical R³ is hydrogen.

3. The crosslinkable composition of claim 1, wherein organopolysiloxanes (B) have a viscosity of from 5 to 150 mPa·s at 25° C.

4. The crosslinkable composition of claim 1, wherein organopolysiloxanes (A) have an average viscosity of from 100 to 10,000 mPa·s at 25° C.

5. The crosslinkable composition of claim 1, wherein the radicals R″ are radicals having a terminal aliphatic carbon-carbon double bond with 2 to 10 carbon atoms.

6. A molding produced by crosslinking the composition (V) of claim 1.

7. The molding of claim 6, which is a coating.

8. The molding of claim 6, which is a covering repelling tacky substances.

9. A process for the production of coatings, comprising applying a crosslinkable composition (V) of claim 1 to a surface to be coated, and subsequently crosslinking the composition.
